(19) United States
(12) Patent Application Publication
(10) Pub. No.: US 2007/0019009 A1
(43) Pub. Date: Jan. 25, 2007

(54) Apparatus and method of controlling a feeding speed and a printing speed

(75) Inventors: Kyung-pyo Kang, Suwon-si (KR); Hyoung-il Kim, Suwon-si (KR)

Correspondence Address: STANZIONE & KIM, LLP, 919 18TH STREET, N.W., SUITE 440, WASHINGTON, DC, 20006, US

(73) Assignee: SAMSUNG Electronics Co., Ltd.

(21) Appl. No.: 11/444,489

(22) Filed: Jun. 1, 2006

(30) Foreign Application Priority Data
Jul. 19, 2005 (KR) 2005-65424

(51) Int. Cl. B41J 29/38

(52) U.S. Cl. 347/5

(57) ABSTRACT

An apparatus and method of controlling a feeding speed and a printing speed of an image forming device. The apparatus includes an encoder to convert a motion of a feeding motor to an electrical signal, an average feeding speed detector to count variations of an output signal of the encoder, to measure a time for counting each of the variations of the output of the encoder, and to calculate an average feeding speed by multiplying the total number of the counted variations by a feeding distance per variation to obtain a result and dividing the result by the sum of the measured times, and a controller to control the feeding speed by controlling the feeding motor based on the calculated average feeding speed. Accordingly, in the image forming device, which uses a DC motor as a driving source of a feeding device, an image length deviation effect that occurs when a length of a printed image is longer or shorter than a desired image length can be reduced by detecting an exact feeding speed of a medium and controlling the feeding speed and a printing speed based on the detected feeding speed of the medium.

### CROSS-REFERENCE TO RELATED APPLICATIONS

This application claims the benefit of Korean Patent Application No.10-2005-0065424, filed on Jul. 19, 2005, in the Korean Intellectual Property Office, the disclosure of which is incorporated herein in its entirety by reference.

### BACKGROUND OF THE INVENTION

1. Field of the Invention

The present general inventive concept relates to an apparatus and method of controlling a feeding speed and a printing speed of an image forming device, and more particularly, to an apparatus and method of controlling a feeding speed and a printing speed of an image forming device by detecting an exact average feeding speed of a feeding motor using an output signal of an encoder attached to the feeding motor.

2. Description of the Related Art

FIG. 1 is a block diagram illustrating a conventional thermal transfer image forming device, which includes a thermal transfer head 100, a thermal transfer head nozzle 110, a thermal transfer head roller 120, a paper feeding roller 130, a paper sensor 140, a feeding motor 150, and an encoder 160.

The thermal transfer head 100 applies heat on a printing paper in a predetermined heating period. The thermal transfer head nozzle 110 ejects ink onto the thermal transfer head roller 120, and then the thermal transfer head roller 120 transfers the ink to the printing paper using the heat applied by the thermal transfer head 100 and feeds the printing paper to the paper feeding roller 130. The paper feeding roller 130 is driven by the feeding motor 150 to move the printing paper, and the paper sensor 140 senses the motion of the printing paper. The feeding motor 150 is a driving source to feed the printing paper to the thermal transfer head 100, and the encoder 160 converts a motion of the feeding motor 150 to an electrical signal.

A controller (not shown) controls a speed of the feeding motor 150 so that a paper feeding speed is equal to a predetermined target average feeding speed. A detailed controlling method is based on a difference between the predetermined target average feeding speed and an average feeding speed that is currently detected. In order to detect the current average feeding speed of the feeding motor 150, each feeding speed is obtained by calculating a feeding distance according to a variation of an output signal of the encoder 160 and dividing the calculated feeding distance by a feeding time. When a plurality of feeding speeds are obtained, the average feeding speed is obtained by summing the feeding speeds and dividing the summed value by the number of feeding speeds. For example, if times periods t1, t2, and t3 are taken to feed a sheet of printing paper by respective distances d1, d2, and d3, an average feeding speed is calculated as (d1/t1+d2/t2+d3/t3)/3. However, if the time periods t1, t2, and t3 are not same, the average feeding speed obtained by the method described above is not an exact average feeding speed. When a feeding speed and a printing time are controlled based on the average feeding speed using an incorrect value obtained using the conventional detecting method described above, a length of a printed image can be longer or shorter than a desired length when the feeding speed and the printing time are controlled using the incorrect value of the average feeding speed.

### SUMMARY OF THE INVENTION

The present general inventive concept provides an apparatus and method of controlling a feeding speed of a feeding device that uses a DC motor and a printing speed in an image forming device, which can reduce an image length deviation effect that results from a deviation of the feeding speed and the printing speed such that a length of a printed image is not longer or shorter than a desired length. The image length deviation effect can be reduced by detecting an exact average feeding speed and controlling the feeding speed and the printing speed based on the detected average feeding speed.

The present general inventive concept also provides an apparatus and method of controlling a feeding speed and/or a printing speed of an image forming device in which an exact average feeding speed is obtained by dividing a total feeding distance by a total feeding time.

Additional aspects of the present general inventive concept will be set forth in part in the description which follows and, in part, will be obvious from the description, or may be learned by practice of the general inventive concept.

The foregoing and/or other aspects of the present general inventive concept may be achieved by providing an apparatus to control a feeding speed and a printing speed of an image forming device, the apparatus including an encoder to convert a motion of a feeding motor to an electrical signal, an average feeding speed detector to count variations of an output signal of the encoder, to measure the time for counting each of the variations of the output signal of the encoder, and to calculate an average feeding speed by multiplying the total number of the counted variations by a feeding distance per variation to obtain a result and dividing the result by the sum of the measured times for each of the variations, and a controller to control the feeding speed by controlling the feeding motor based on the calculated average feeding speed.

The average feeding speed detector may include a counter to count the variations of the output signal of the encoder, a counter variation time measurement unit to measure the time of each of the variations when the counter varies by a predetermined value, and an average feeding speed calculator to calculate the average feeding speed by multiplying a unit feeding distance fed in each of the variations of the output signal of the encoder by a total variation value of the counter and dividing the multiplied result by a sum of the measured counter variation times.

The controller may control printing by setting a current printing speed based on a compensated feeding speed.

The foregoing and/or other aspects of the present general inventive concept may also be achieved by providing a feeding speed control apparatus usable with an image forming device, the apparatus including an average feeding speed detector to detect an average feeding speed of a print medium being fed by a feeding motor in the image forming device by accumulating a total motion distance from a plurality of discrete motion distances of the feeding motor, accumulating a total motion time from a plurality of motion times corresponding to the plurality of discrete motion distances, and dividing the total motion distance by the total motion time to calculate the average feeding speed, and a controller to adjust a power signal provided to the feeding motor based on the detected average feeding speed.

The foregoing and/or other aspects of the present general inventive concept may also be achieved by providing a feeding speed control apparatus, including a feeding motor to drive a feeding unit to feed a print medium in an image forming device, an encoder to sense a motion the feeding motor, an average feeding speed detector to detect an average feeding speed of the print medium by determining a rotational distance of the feeding motor over a single predetermined time interval according to the motion sensed by the encoder, and a controller to regulate the average feeding speed of the print medium by adjusting a driving signal provided to the feeding motor based on the detected average feeding speed.

The foregoing and/or other aspects of the present general inventive concept may also be achieved by providing an image forming device, including an image printing unit to print an image on a print medium, a feeding unit to feed the print medium to the image printing unit, a feeding motor to drive the feeding unit, an average feeding speed detector to detect an average feeding speed of the feeding motor by accumulating a total motion distance from a plurality of discrete motion distances of the feeding motor, accumulating a total motion time from a plurality of motion times corresponding to the plurality of discrete motion distances, and dividing the total motion distance by the total motion time to calculate the average feeding speed of the print medium, and a controller to adjust a power signal provided to the feeding motor based on the detected average feeding speed.

The foregoing and/or other aspects of the present general inventive concept may also be achieved by providing an image forming device, including a feeding unit to feed a print medium along a printing path, a feeding motor to drive the feeding unit, an image printing unit to print an image on the print medium being fed along the printing path, an encoder to sense a motion of the feeding motor to detect an average feeding speed of the print medium, and a controller to regulate the average feeding speed of the print medium by adjusting a driving signal provided to the feeding motor based on the detected average feeding speed of the print medium and to regulate a printing speed of a printing operation to match the average feeding speed of the print medium. The controller adjusts a first feeding speed to a second feeding speed based on the detected average feeding speed, determines a ratio between the second feeding speed and the first feeding speed, applies the ratio to a first printing speed to obtain a second printing speed, and controls the image printing unit and the feeding motor to operate at the second printing speed and the second feeding speed, respectively.

The foregoing and/or other aspects of the present general inventive concept may also be achieved by providing a method of controlling a feeding speed and a printing speed of an image forming device, the method including converting a motion of a feeding motor to an electrical signal, counting variations of the converted electrical signal and measuring a time for counting each of the variations, multiplying a unit feeding distance fed in each of the variations of the electrical signal by the number of the counted variations and calculating an average feeding speed by dividing the multiplied result by a sum of the measured times for each of the variations, and controlling the feeding speed by controlling the feeding motor based on the calculated average feeding speed.

The method may further include controlling a printing operation of the image forming device by setting a current printing speed based on a compensated feeding speed.

The foregoing and/or other aspects of the present general inventive concept may also be achieved by providing a computer readable recording medium containing executable code to control a feeding speed and a printing speed of an image forming device, the medium including executable code to convert a motion of a feeding motor to an electrical signal, executable code to count variations of the converted electrical signal and to measure a time for counting each of the variations of the electrical signal, executable code to multiply a unit feeding distance fed in each of the variations of the electrical signal by the number of the counted variations and to calculate the average feeding speed by dividing the multiplied result by a sum of the measured times for each of the variations, and executable code to control the feeding speed by controlling the feeding motor based on the calculated average feeding speed.

### BRIEF DESCRIPTION OF THE DRAWINGS

These and/or other aspects of the present general inventive concept will become apparent and more readily appreciated from the following description of the embodiments, taken in conjunction with the accompanying drawings of which:

FIG. 1 is a block diagram illustrating a conventional thermal transfer image forming device;

FIG. 2 is a block diagram illustrating an apparatus to control a feeding speed of an image forming device according to an embodiment of the present general inventive concept;

FIG. 3 is a detailed block diagram illustrating an average feeding speed detector of the feeding speed control apparatus of FIG. 2, according to an embodiment of the present general inventive concept;

FIG. 4 is a block diagram illustrating an apparatus to control a feeding speed and a printing speed of an image forming device according to an embodiment of the present general inventive concept; and

FIG. 5 is a flowchart illustrating a method of controlling a feeding speed and a printing speed of an image forming device according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

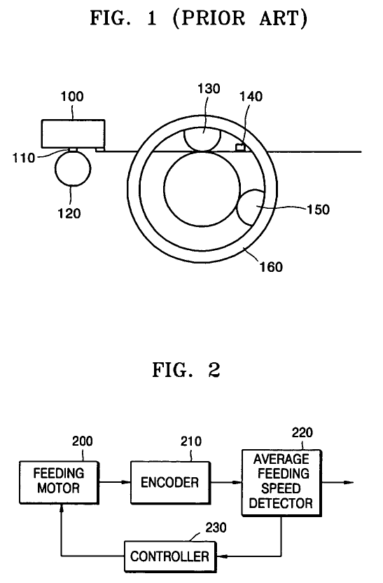

FIG. 2 is a block diagram illustrating an apparatus to control a feeding speed according to an embodiment of the present general inventive concept, which includes a feeding motor 200, an encoder 210, an average feeding speed detector 220, and a controller 230.

Referring to FIG. 2, the feeding motor 200 feeds a print medium by operating according to an amount of a current output by the controller 230. The encoder 210 converts a motion of the feeding motor 200 to an electrical signal. The electrical signal may be a square wave or a sine wave.

The average feeding speed detector 220 counts variations of the output signal of the encoder 210, measures a time for counting each of the variations, and calculates an average feeding speed by multiplying a feeding distance per unit variation by the number of the counted variations to obtain a result and dividing the result by a sum of the measured times. The calculated average feeding speed is output to the controller 230 and is used to control the feeding speed. The encoder 210 may include an encoder scale (not shown) coupled to the feeding motor 200 to move according to operation of the feeding motor 200, and an encoder sensor (not shown) to sense the motion of the encoder scale as a plurality of variations (e.g., pulses, waves, etc.) The encoder scale may include a plurality of marks that are sensed by the encoder sensor. The encoder 210 may be rotationally driven by the feeding motor 200 such that each of the variations indicates an equidistant rotational distance (i.e., discrete motion distances) of the feeding motor 200. Other arrangements may also be used with the present general inventive concept.

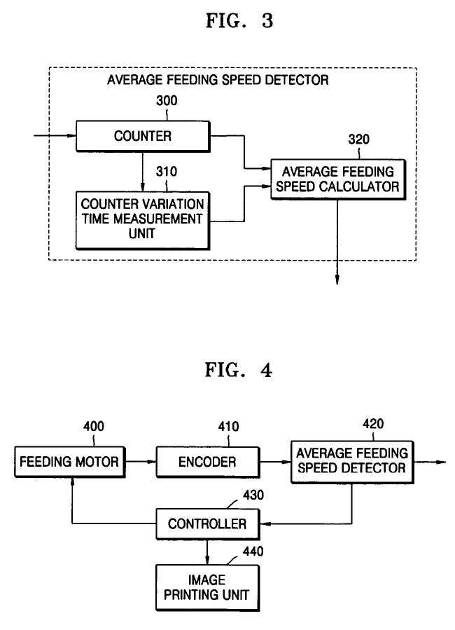

FIG. 3 is a detailed block diagram illustrating the average feeding speed detector 220 of FIG. 2 according to an embodiment of the present general inventive concept, which includes a counter 300, a counter variation time measurement unit 310, and an average feeding speed calculator 320.

Referring to FIGS. 2 and 3, the counter 300 counts the variations of the output signal of the encoder 210. The counting of the variations of the output signal of the encoder 210 can be achieved by counting rising edges, falling edges, or constant portions of the output signal when the output signal is a square wave. Alternatively, the counting of the variations of the output signal of the encoder 210 can be achieved by counting maximum or minimum values of the output signal when the output signal is a sine wave.

The counter variation time measurement unit 310 measures the time for counting each of the variations every time a value of the counter 300 varies by a predetermined value. The predetermined value can be 1 or a natural number larger than 1. The counter 300 varies by the predetermined value each time a variation in the output signal of the encoder 210 is detected. The variation in the output signal of the encoder 210 may be detected when, for example, the output signal is at a local maximum, the output signal goes from logic low to logic high, the output signal increases by a predetermined amount, etc. For example, the counter 300 may be incremented by a value of 1 each time a variation in the output signal occurs. Thus, the value of the counter 300 (i.e., the counter value) indicates the number of variations of the output signal of the encoder 210, since some initial value or point in time. Accordingly, the counter value varies along with the output signal of the encoder 210. The counter variation time measurement unit 310 measures the time it takes the counter value to change by the predetermined value (e.g., by being incremented by 1).

The average feeding speed calculator 320 calculates the average feeding speed by multiplying a unit feeding distance fed in each of the variations of the output signal of the encoder 210 by a total variation value of the counter 300 (i.e., the total number of variations) and dividing the multiplied result by a sum of the measured counter variation times. The unit feeding distance is a distance by which a print medium is fed while the output signal of the encoder 210 is varied. The unit feeding distance is a predetermined value according to a pinch roller (not shown) feeding media. In other words, the encoder 210 measures the unit feeding distance and outputs one variation in the output signal for each unit feeding distance.

That is, the average feeding speed calculator 320 calculates the average feeding speed using Equation 1:

$$average feeding speed = \frac{( d {\sum }_{n = 1}^{N} {C}_{i} )}{{\sum }_{n = 1}^{N} {T}_{i}} \qquad ( 1 )$$

where C₁, C₂, and C_{N} are variations of the counter 300 changed during measured times taken T₁, T_{2, and T}_{N}. The counter 300 and the counter variation time measurement unit 310 respectively obtain N samples such as Cₙ and Tₙ. The character “d” represents the unit feeding distance (described above).

When the predetermined value by which the counter varies is 1, values C₁, C₂, and C_{N} are 1. However, the predetermined value can be set to other values and may vary. That is, if the predetermined value is changed for every measured sample, the values C₁, C₂, and C_{N} may be different from each other.

The controller 230 increases a speed of the feeding motor 200 by increasing the amount of the current supplied to the feeding motor 200 when a target average feeding speed set as a target of the feeding speed control is greater than the average feeding speed detected by the average feeding speed detector 220. Similarly, the controller 230 decreases the speed of the feeding motor 200 by decreasing the amount of the current supplied to the feeding motor 200 when the target average feeding speed is less than the detected average feeding speed. That is, the controller 230 controls the feeding speed by compensating for the speed of the feeding motor 200 by a difference between the set target average feeding speed and the detected average feeding speed. The compensation method may be a proportional, integral, and differential (PID), PI, or P control method.

FIG. 4 is a block diagram illustrating an apparatus to control a feeding speed and a printing speed of an image forming device according to an embodiment of the present general inventive concept, which includes a feeding motor 400, an encoder 410, an average feeding speed detector 420, a controller 430, and an image printing unit 440.

Since operations and functions of the feeding motor 400, the encoder 410, and the average feeding speed detector 420 may be similar to those of the feeding motor 200, the encoder 210, and the average feeding speed detector 220 illustrated in FIG. 2, descriptions thereof will not be provided.

The controller 430 controls not only the feeding speed but also the printing speed. That is, the controller 430 controls a printing operation by setting the printing speed based on the compensated feeding speed and can do so using a variety of methods. For example, a current target printing speed is set by multiplying a previous target printing speed by a compensation ratio. The controller 430 controls the image printing unit 440 so that the image printing unit 440 prints an image based on the current target printing speed. The compensation ratio can be obtained by dividing the compensated feeding speed (i.e., current feeding speed) by the feeding speed before the compensation (i.e., previous printing speed), dividing the target average feeding speed by the detected average feeding speed, or using other various methods.

A method of controlling a printing speed may also control the printing speed by setting a printing time required to perform a unit print without directly setting the printing speed. That is, the controller 430 can control the image printing unit 440 so that the image printing unit 440 prints an image based on a current printing time by multiplying a previously set printing time by the compensation ratio (described above) and setting the multiplication product of the previously set printing time and the compensation ratio as the current printing time.

The controller 430 can control the image printing unit 440 so that the image printing unit 440 prints an image by forming the image on a print medium fed at the set printing speed. An effect of a variation in the average feeding speed of the feeding motor 400 resulting from internal and external environments of the image forming device can be effectively compensated for when the controller 430 controls the feeding speed and the printing speed, and an image length deviation effect that results from a mismatch between the feeding speed and the printing speed can be effectively prevented.

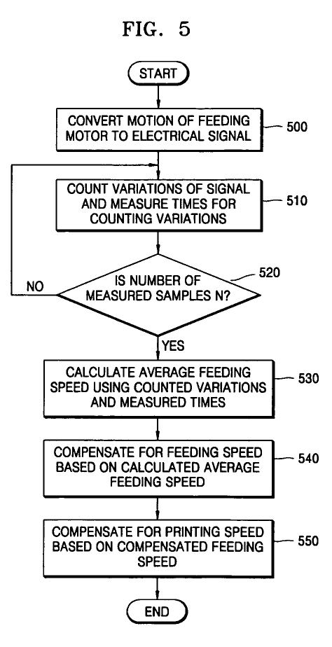

FIG. 5 is a flowchart illustrating a method of controlling a feeding speed and a printing speed of an image forming device according to an embodiment of the present general inventive concept. The method of FIG. 5 can be performed by the apparatus of FIG. 2 and/or the apparatus of FIG. 4. Accordingly, for illustration purposes, the method of FIG. 5 is described below with reference to FIGS. 2 to 5.

Referring to FIG. 5, a motion of the feeding motor 400 is converted to an electrical signal by, for example, the encoder 410 (or 210) in operation 500. The electrical signal (i.e., the output signal of the encoder 410 or 210) is, for instance, a square wave or a sine wave.

In operation 510, the number of variations of the output signal of the encoder 410 is counted by the counter 300 of the average feeding speed detector 420 (or 220), and simultaneously a time for counting each of the variations is measured by the counter variation time measurement unit 310 every time the output signal varies by a predetermined amount. In order to count the variations of the output signal of the encoder 410 (or 210), the method of using rising or falling edges of the electrical signal (as described above) may be used.

In operation 520, it is determined whether the number of samples of the measured time is a predetermined value N. If it is determined that the number of samples of the measured time is not the predetermined value N, operations 510 and 520 are repeated until the number of samples of the measured time is the predetermined value N. The samples may be taken for each predetermined unit of time (e.g., 1 ns, 1 ms, etc.). Accordingly, the predetermined value N indicates an amount of time for which the variations in the output signal of the encoder 410 (or 210) are counted. The predetermined value N also indicates an interval of time over which the average feeding speed is detected/calculated.

In operation 530, the average feeding speed calculator 320 calculates an average feeding speed using Equation 1 with the counter variations C₁, C₂, and C_{N}. provided by the counter 300 and T₁, T₂, and T_{N} provided by the counter variation time measurement unit 310. That is, the average feeding speed calculator 320 calculates the average feeding speed by counting the variations of the output signal of the encoder 410 (or 210), measuring the times for counting the variations, multiplying the number of the counted variations by a unit feeding distance per variation, and dividing the multiplied result by a sum of the measured times between each sample.

In operation 540, the controller 430 (or 230) compensates for the feeding speed using the calculated average feeding speed. That is, the controller 430 (or 230) controls a speed of the feeding motor 400 (or 200) to compensate for the feeding speed by a value obtained by subtracting the detected average feeding speed from the target average feeding speed.

In operation 550, the controller 430 compensates for the printing speed based on the compensated feeding speed and controls the image printing unit 440 based on the compensated printing speed. That is, the controller 430 controls printing by dividing the compensated feeding speed by a feeding speed before the compensation (i.e., the previous feeding speed), multiplying the divided result by the previous target printing speed, and setting the multiplied result as the current printing speed. In other words, the controller calculates the printing speed based on the compensated feeding speed and controls the printing operation according the calculated printing speed.

The general inventive concept can be embodied as computer readable codes on a computer readable recording medium. The computer readable recording medium may be any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion. Also, functional programs, codes, and code segments for accomplishing the present general inventive concept can be easily construed by programmers skilled in the art to which the present general inventive concept pertains. For example, the controller 230 and/or the controller 430 may be implemented as a computer program.

As described above, according to embodiments of the present general inventive concept, in an image forming device, which uses a DC motor as a driving source of a feeding device, an image length deviation effect when a length of a printed image is longer or shorter than a desired image length can be reduced by detecting an exact feeding speed of a print medium and controlling the feeding speed and a printing speed based on the detected feeding speed of the print medium.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An apparatus to control a printing speed of an image forming device, the apparatus comprising:
an encoder to convert a motion of a feeding motor to an electrical signal;
an average feeding speed detector to count variations of an output signal of the encoder, to measure a time for counting each of the variations of the output signal of the encoder, and to calculate an average feeding speed by multiplying the total number of the counted variations by a feeding distance per variation to obtain a result and dividing the result by a sum of the measured times of each variation; and
a controller to control the feeding speed by controlling the feeding motor based on the calculated average feeding speed.

2. The apparatus of claim 1, wherein the average feeding speed detector comprises:
a counter to count the variations of the output signal of the encoder;
a counter variation time measurement unit to measure a time for counting each of the variations when the counter varies by a predetermined value; and
an average feeding speed calculator to calculate the average feeding speed by multiplying a unit feeding distance fed in each of the variations of the output signal of the encoder by a total variation value of the counter and dividing the multiplied result by a sum of the measured counter variation times.

3. The apparatus of claim 1, wherein the variations of the output signal of the encoder are counted using rising or falling edges of the output signal of the encoder.

4. The apparatus of claim 1, wherein the controller controls a speed of the feeding motor to compensate for the feeding speed using a result obtained by subtracting the calculated average feeding speed from a pre-set target average feeding speed.

5. The apparatus of claim 1, wherein the controller controls a printing operation of the image forming device by setting a current printing speed based on a compensated feeding speed.

6. The apparatus of claim 5, wherein the controller controls the printing operation by dividing the compensated feeding speed by a feeding speed before the compensation, multiplying the divided result by a previous target printing speed, and setting the multiplied result as a current printing speed.

7. A feeding speed control apparatus usable with an image forming device, the apparatus comprising:
an average feeding speed detector to detect an average feeding speed of a print medium being fed by a feeding motor in the image forming device by accumulating a total motion distance from a plurality of discrete motion distances of the feeding motor, accumulating a total motion time from a plurality of motion times corresponding to the plurality of discrete motion distances, and dividing the total motion distance by the total motion time to calculate the average feeding speed; and
a controller to adjust a power signal provided to the feeding motor based on the detected average feeding speed.

8. The control apparatus of claim 7, further comprising:
an encoder operated by the feeding motor to produce an output signal that varies for each unit distance and to provide the output signal to the average feeding speed detector so that the average feeding speed detector detects the average feeding speed from the output signal.

9. The control apparatus of claim 8, wherein the average feeding speed detector comprises:
a counter to count the variations in the output signal of the encoder;
a counter variation time measurement unit to detect a time that corresponds to each of the variations of the output signal; and
an average feeding speed calculator to determine a total number of variations of the output signal, determine a total time for all the variations of the output signal, to divide the total number of variations of the output signal by the total time to obtain a result, and to multiply the result by the unit distance.

10. The control apparatus of claim 7, wherein the average feeding speed detector detects the average speed according to:
$$average feeding speed = \frac{( d {\sum }_{n = 1}^{N} {C}_{i} )}{{\sum }_{n = 1}^{N} {T}_{i}}$$
where N represents time samples, Cᵢ represents the discrete motion distances, Tᵢ represents time measured for traveling the discrete motion distances Cᵢ, and “d” represents a unit feeding distance for each discrete motion distance.

11. The control apparatus of claim 7, wherein the controller determines a difference between a target average feeding speed of the feeding motor and the detected average feeding speed of the feeding motor and adjusts the power signal provided to the feeding motor by an amount that is proportional to the difference.

12. A feeding speed control apparatus, comprising:
a feeding motor to drive a feeding unit to feed a print medium in an image forming device;
an encoder to sense a motion the feeding motor;
an average feeding speed detector to detect an average feeding speed of the print medium by determining a rotational distance of the feeding motor over a single predetermined time interval according to the motion sensed by the encoder; and
a controller to regulate the average feeding speed of the print medium by adjusting a driving signal provided to the feeding motor based on the detected average feeding speed.

13. An image forming device, comprising:
an image printing unit to print an image on a print medium;
a feeding unit to feed the print medium to the image printing unit;
a feeding motor to drive the feeding unit;
an average feeding speed detector to detect an average feeding speed of the feeding motor by accumulating a total motion distance from a plurality of discrete motion distances of the feeding motor, accumulating a total motion time from a plurality of motion times corresponding to the plurality of discrete motion distances, and dividing the total motion distance by the total motion time to calculate the average feeding speed of the print medium; and
a controller to adjust a power signal provided to the feeding motor based on the detected average feeding speed.

14. The image forming device of claim 13, wherein the controller regulates a printing speed of the image printing unit to match a feeding speed of the feeding motor.

15. An image forming device, comprising:
a feeding unit to feed a print medium along a printing path;
a feeding motor to drive the feeding unit;
an image printing unit to print an image on the print medium being fed along the printing path;
an encoder to sense a motion of the feeding motor to detect an average feeding speed of the print medium; and
a controller to regulate the average feeding speed of the print medium by adjusting a driving signal provided to the feeding motor based on the detected average feeding speed of the print medium and to regulate a printing speed of a printing operation to match the average feeding speed of the print medium,
wherein the controller adjusts a first feeding speed to a second feeding speed based on the detected average feeding speed, determines a ratio between the second feeding speed and the first feeding speed, applies the ratio to a first printing speed to obtain a second printing speed, and controls the image printing unit and the feeding motor to operate at the second printing speed and the second feeding speed, respectively.

16. The image forming device of claim 15, wherein the encoder is driven by the feeding motor and includes a plurality of marks and a sensor to produce an output signal having a plurality of variations indicating equidistant rotational distances of the feeding motor.

17. The image forming device of claim 15, further comprising:
an average feeding speed detector to detect the average feeding speed of the print medium by determining a rotational distance of the feeding motor over a predetermined time interval using the encoder and to provide the detected average feeding speed of the print medium over the predetermined time interval to the controller.

18. A method of controlling a feeding speed and a printing speed of an image forming device, the method comprising:
converting a motion of a feeding motor to an electrical signal;
counting variations of the converted electrical signal and measuring a time for counting each of the variations;
multiplying a unit feeding distance fed in each of the variations of the electrical signal by the number of the counted variations and calculating the average feeding speed by dividing the multiplied result by a sum of the measured times for each of the variations; and
controlling the feeding speed by controlling the feeding motor based on the calculated average feeding speed.

19. The method of claim 18, wherein the counting of the variations comprises counting rising or falling edges of the electrical signal.

20. The method of claim 18, wherein the controlling of the feeding speed comprises controlling a speed of the feeding motor to compensate for the feeding speed using a result obtained by subtracting the calculated average feeding speed from a pre-set target average feeding speed.

21. The method of claim 18, further comprising:
controlling a printing operation of the image forming device by setting a current printing speed based on a compensated feeding speed.

22. The method of claim 21, wherein the controlling of the printing operation comprises:
dividing the compensated feeding speed by a feeding speed before the compensation;
multiplying the divided result by a previous target printing speed; and
setting the multiplied result as a current printing speed.

23. A computer readable recording medium having recorded thereon a computer readable program to perform a method of controlling a feeding speed and a printing speed of an image forming device, the medium comprising:
executable code to convert a motion of a feeding motor to an electrical signal;
executable code to count variations of the converted electrical signal and measuring a time for counting each of the variations;
executable code to multiply a unit feeding distance fed in each of the variations of the electrical signal by the number of the counted variations and to calculate the average feeding speed by dividing the multiplied result by a sum of the measured times for each of the variations; and
executable code to control the feeding speed by controlling the feeding motor based on the calculated average feeding speed.

24. The medium of claim 23, wherein the executable code to count the variations comprises executable code to count rising or falling edges of the electrical signal.

25. The medium of claim 23, wherein the executable code to control the feeding speed comprises executable code to control a speed of the feeding motor to compensate for the feeding speed using a result obtained by subtracting the calculated average feeding speed from a pre-set target average feeding speed.

26. The medium of claim 23, further comprising:
executable code to control a printing operation of the image forming device by setting a current printing speed based on a compensated feeding speed.

27. The medium of claim 26, wherein the executable code to control the printing operation comprises:
executable code to divide the compensated feeding speed by a feeding speed before the compensation;
executable code to multiply the divided result by a previous target printing speed; and
executable code to set the multiplied result as the current printing speed.
